(19) United States
(12) Patent Application Publication
(10) Pub. No.: US 2009/0114320 A1
(43) Pub. Date: May 7, 2009

(54) PERSONAL SECURITY WALLET AND METHOD OF USE THEREOF

(76) Inventor: Jesse Flood, Austell, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/936,329

(22) Filed: Nov. 7, 2007

(51) Int. Cl. A45C 1/06; F21K 5/16

(52) U.S. Cl. 150/134; 431/2; 431/357

(57) ABSTRACT

A personal security wallet comprising a flashbulb, such as, for exemplary purposes only, a xenon flashtube, contained on the front of the wallet within a window covered by a concentrating lens; a charge storage mechanism within the wallet spine, such as, for exemplary purposes only, a capacitor, wherein the charge storage mechanism is in electrical communication with the flashbulb; an activation switch on the back of the wallet in communication with the charge storage mechanism; a disabling switch inside the wallet in electrical communication between the charge storage mechanism; and an energy source within the wallet spine, wherein the energy source comprises a battery.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to personal security devices, and more specifically to a personal security wallet with flash bulb and charging circuitry enclosed therewithin, wherein a person carrying the wallet can activate the flash bulb to temporarily blind an assailant, facilitating escape.

2. Description of Related Art

The amount of violent crime committed in the United States against defenseless victims is very high and, consequently, there is a strong demand for effective self defense devices. Many citizens have been motivated to rely upon personal protection alarms and security devices that do not rely upon the conventional police forces in the community.

It is prevalent and typical that persons carrying their personal funds usually carry same in a wallet or pocket book, wherein the former is often carried in a pocket on the person, whilst the latter is often carried in a purse or handbag. Typically, the wallet is a folded cloth or leather apparatus that holds not only paper money, but also identification cards, government-issued licenses, credit cards and the like. Accordingly, an individual places great value on the wallet and its contents and does not readily wish to give it up when demanded to do so by a thief.

Notwithstanding, a robber may be armed and/or put forth an aggressive demeanor that places the individual in fear. Accordingly, without other recourse, the individual cannot readily escape from the robber, and, upon releasing their wallet, incurs possible substantial loss of funds and great inconvenience in replacing their documents.

While various devices and methods exist for alerting the owner of a wallet that it has surreptitiously been removed from their pocket or purse, previous devices do not provide the ability to disable a thief. For instance, some previous devices have sensors to detect when they are removed from the pocket or other place of concealment. Such sensors typically activate a signaling device to alert the owner that the wallet has been removed. Other devices rely on securing cords or strings to prevent their removal.

Further, the use of signaling devices does not otherwise deter a thief. Accordingly, some previous devices have included an alarm to attract attention of bystanders and/or police officers in the vicinity. However, if there are no bystanders, or if same do not wish to assist, and if there are no police officers present, the alarm will be of little use. Thus, the principal disadvantage lies in the fact that the alarm mechanism in and of itself often does not deter the thief from taking the valuable wallet and subsequently escaping with it.

There are previous devices that are designed to incapacitate a robber. For instance, one such device discharges tear gas. Unfortunately, depending on the wind conditions, such a device may well incapacitate the user as well or alone. Further, accidental discharge of such device in a pocket or purse can be extremely hazardous and inconvenient.

Other devices such as blank pistols, electric shock, odor creating devices, and the like, often pose more danger for the user than for the person against whom they are likely to be utilized. In addition, a limitation of such devices is that they would not typically be carried by the user in the hand but would necessarily require retrieving from a pocket or purse, which could alert a robber and cause aggressiveness. Many robberies, muggings or other assaults do not allow the person being attacked sufficient time to reach into a pocket or purse to locate a personal security device and then use it before being attacked, except when the robber so directs.

One device incorporates a flash bulb into a gun that must be pointed at a robber to blind the robber. However, a robber seeing an attempt to retrieve a gun-like object may naturally attempt to overcome the victim, causing bodily harm. Additionally, such a gun-like object could be mistaken by a police officer as threatening and could result in harm if seen by the officer. Lastly, such a protective device requires the user to carry an additional device with them, resulting in bulkiness, weight and other inconvenience.

Another device utilizes light to attract a waiter so that he waiter will pick up a restaurant patron's bill. However, such a device is larger and bulkier than what would be carried on the person. More importantly, such a device is designed to attract, not to repel and is thus not suitable as a deterrent via incapacitation of a robber.

Therefore, it is readily apparent that there is a need for a personal security wallet that overcomes the aforementioned disadvantages and provides an apparatus that can be carried in the fashion of a standard wallet, either on the person or within a purse, wherein the wallet is utilized to temporarily disable an assailant to permit the owner time to escape.

### BRIEF SUMMARY OF THE INVENTION

Briefly described, in a preferred embodiment, the present invention overcomes the above-mentioned disadvantages and meets the recognized need for such a device by providing a personal security wallet having therein a blinding flash bulb that is activated by operation of a push button on the back of the outer shell of the wallet. When accosted by a robber who demands money, the victim, who has the personal security wallet, retrieves same from his/her pocket or purse, as directed by the robber, aims the bulb at the robber and depresses the button, thereby blinding the robber, permitting the victim to escape. The flash is powered by a charge storage apparatus such as, without limitation, a capacitor, which in turn is charged from an energy source, such as, without limitation a battery. The battery could comprise a rechargeable battery, wherein the battery is recharged by insertion of the personal security wallet into a charger cradle that is connected to a power supply. To prevent accidental activation when in a safe environ, the personal security wallet can be switched off by disengagement of the energy source from the charge storage apparatus via a switch. The switch also engages contacts on the personal security wallet that mate with charger contacts when in the ‘off’ position to recharge the battery within the personal security wallet.

Thus, by providing a personal security wallet that can disable an assailant, the present invention permits an individual to escape from the assailant. Because the wallet is the target of the robber, it is quite natural to retrieve same from a pocket and begin to hand it over to the robber without alarming the robber and causing same to become aggressive and possibly render bodily harm.

According to its major aspects and broadly stated, the present invention in its preferred form is a personal security wallet comprising a flashbulb, such as, for exemplary purposes only, a xenon flashtube, contained on the front of the wallet within a window covered by a concentrating lens; a charge storage mechanism within the wallet spine, such as, for exemplary purposes only, a capacitor, wherein the charge storage mechanism is in electrical communication with the flashbulb; an activation switch on the back of the wallet in communication with the charge storage mechanism; a disabling switch inside the wallet in electrical communication between the charge storage mechanism and an energy source within the wallet spine, wherein the energy source comprises a battery.

The disabling switch removes electrical communication between the energy source and the charge storage mechanism and, in an alternated embodiment, the switch could selectively simultaneously engage electrical communication between charging contacts on the wallet and contacts within a charger, wherein a rechargeable battery is charged via the charging contacts.

In order to disable an assailant, the charge storage mechanism contained within the wallet is previously charged with energy from the battery within the wallet, and when the wallet is removed from where it is carried on the person or in a purse, the wallet is aimed at the assailant. The person carrying the wallet presses an activation button switch, discharging the charge storage mechanism through the flashbulb, thereby disabling the assailant by temporary blinding the assailant.

In the preferred embodiment, electrical communication between the battery and the charge storage mechanism is disengageable by a switch, and, in the alternate embodiment, the battery is recharged by simultaneous connection between the battery and the charger via the contacts on the wallet, when the wallet is disposed in a cradle of the charger.

Thus, the present invention provides a device that is a modification of a wallet that would normally be carried by an individual, while at the same time provides increased protection by facilitating in escape when threatened by a robber.

More specifically, the present invention is a personal security wallet having an outer portion, a spine and an inner portion. The outer portion comprises a front and a back, wherein the front comprises a window, a flash bulb and a lens, and wherein the flash bulb is disposed behind the lens. The lens concentrates and amplifies light into a narrow beam. The back has thereon an activation button for firing the flash bulb.

The inner portion of the personal security wallet has an on-off switch for disengaging power to the flash bulb. Disposed within the spine is an energy source, such as a battery, and a storage mechanism. The storage mechanism comprises, for exemplary purposes only, a capacitor. The flash bulb is in electrical communication with the storage mechanism and the activation button, such that depressing the activation button releases energy from the storage mechanism to the flash bulb, firing same. The storage mechanism is in electrical communication with the energy source via a switch, wherein the storage mechanism can be disengaged from the energy source.

During an attempted robbery by a robber of a victim who has a personal security wallet of the present invention, upon demand by the robber for the victim's money, the victim removes his/her personal security wallet, holding same in his/her hand, ensuring that the front of the outer portion is disposed facing the robber, such that the window is aimed at the robber's eyes. Subsequently, the victim activates the flash bulb by depressing the activation button with his/her thumb or fingers. Upon activation of the flash bulb, the resulting flash temporarily blinds the robber leaving the robber disoriented and enabling the victim to escape in possession of his/her wallet.

When the victim is at home and does not want accidental activation of the flash bulb of personal security wallet, and/or wishes to conserve energy within the internal energy source, the victim operates the on-off switch, selecting the ‘off’ position. Switching the switch to the ‘off’ position disengages electrical communication between the energy source and the energy storage mechanism, so that the latter will not receive electrical energy for recharge.

In an alternate embodiment, the energy source could be a rechargeable battery. In such alternate embodiment, the wallet is disposed within a cradle of charger that is in electrical communication with mains power via a power cord. The charger could alternately be connected to any electrical energy supply, including, without limitation, an automobile lighter power outlet.

Insertion of the wallet into the cradle places the personal security wallet in electrical communication with the charger and ultimately with the mains power via the power cord to replenish the power source with energy. Subsequently, the power source provides its stored energy for activation of the flash bulb once the wallet is removed and the switch is switched to the ‘on’ position, so that energy flows from the energy source to the storage mechanism.

Selection of the ‘off’ position of the switch further places a set of contacts on the personal security wallet in electrical communication with the energy source. The contacts engage cooperative contacts of the charger, thereby permitting flow of electrical energy from the charger to the energy source to recharge same.

Thus, there is provided a wallet as carried by a person having the security function of providing the ability to render an assailant incapacitated.

Accordingly, a feature and advantage of the present invention is its ability to temporarily blind an assailant.

Another feature and advantage of the present invention is its ability to be disabled when in secure areas, thereby conserving energy.

Still another feature and advantage of the present invention is its ability to function as a normal wallet.

Yet another feature and advantage of the present invention is its ability to be recharged.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a perspective view of the outside of a personal security wallet according to a preferred embodiment of the present invention;

FIG. 2 is a perspective view of the inside of a personal security wallet according to a preferred embodiment of the present invention;

FIG. 3 is a perspective view of a personal security wallet according to a preferred embodiment of the present invention, shown in use; and

FIG. 4 is a perspective view of a personal security wallet according to an alternate embodiment of the present invention.

### DETAILED DESCRIPTION OF THE PREFERRED AND SELECTED ALTERNATE EMBODIMENTS OF THE INVENTION

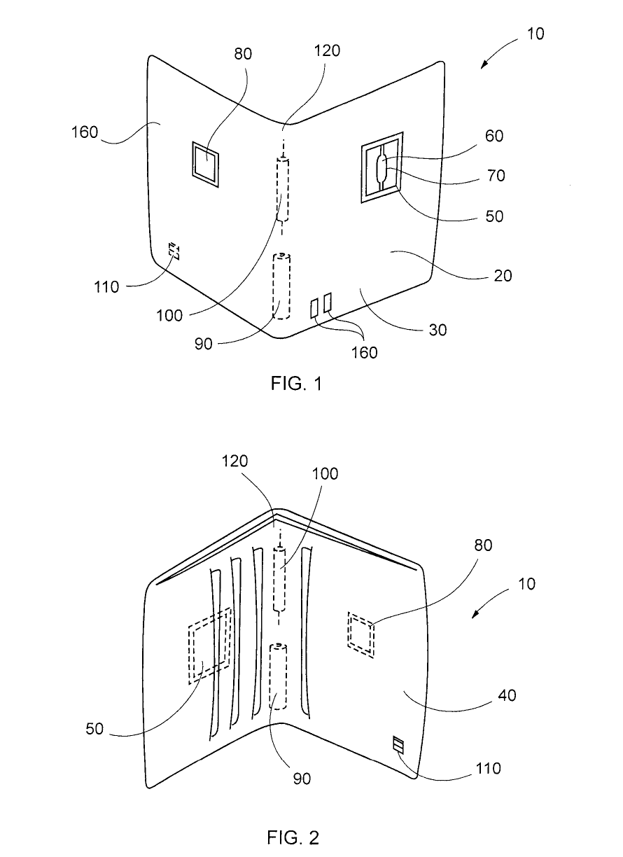

In describing the preferred and selected alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment is personal security wallet 10, wherein personal security wallet 10 comprises outer portion 20, spine 120 and inner portion 40. Outer portion 20 comprises front 30 and back 160, wherein front 30 comprises window 50, flash bulb 60 and lens 70, and wherein flash bulb 60 is disposed behind lens 70. Lens 70 comprises a magnifying and aiming lens, wherein lens 70 concentrates and amplifies light from flash of flash bulb 60 into a powerful and directional narrow beam. Back 160 comprises activation button 80, wherein depression of activation button 80 causes flash bulb 60 to emit a brief, blinding pulse of light. Flash bulb 60 comprises, for exemplary purposes only, a xenon flash tube, wherein flash bulb 60 emits a blinding flash of light for duration of approximately 0.001 seconds.

Inner portion 40 comprises switch 110. Disposed within spine 120 is energy source 90 and storage mechanism 100, wherein energy source 90 comprises, for exemplary purposes only, a battery. Storage mechanism 100 comprises, for exemplary purposes only, a capacitor. Flash bulb 60 is in electrical communication with storage mechanism 100 and activation button 80. Storage mechanism 100 is in electrical communication with energy source 90 and switch 110.

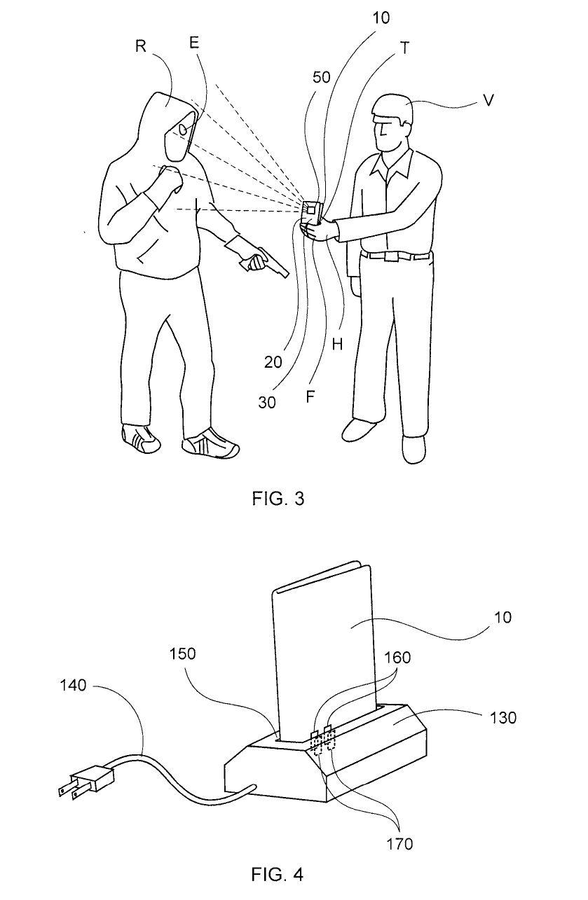

In use (best shown in FIG. 3), during an attempted robbery by robber R of victim V, upon request of robber R for money, victim V removes security wallet 10, holding same in hand H, ensuring that front 30 of outer portion 20 is disposed facing robber R, wherein window 50 is aimed at robber's eyes E. Subsequently, victim V activates flash bulb 60 by depressing activation button 80 with thumb T. Upon activation of flash bulb 60, the resulting flash blinds robber R, enabling victim V to escape. It will be recognized by those skilled in the art, that other means of depression of activation button 80 could be utilized such as, for exemplary purposes only, fingers F of victim V.

When victim V is at home and does not want accidental activation of flash bulb 60 of security wallet 10, victim V operates switch 110, wherein switch 110 comprises an on-off switch. Switching switch 110 to the ‘off’ position reversibly disengages electrical communication between energy source 90 and energy storage mechanism 100, wherein energy storage mechanism 100 will not receive electrical energy for recharge.

Referring now more specifically to FIG. 4, illustrated therein is an alternate embodiment of device 10, wherein the alternate embodiment of FIG. 4 is substantially equivalent in form and function to that of the preferred embodiment detailed and illustrated in FIGS. 1-3 except as hereinafter specifically referenced. Specifically, the embodiment of FIG. 4 comprises security wallet 10, wherein energy source 90 (best shown in FIGS. 1 and 2) is a rechargeable battery. In this alternate embodiment, wallet 10 is disposed within cradle 150 of charger 130, wherein charger 130 is in electrical communication with mains power via power cord 140. It will be recognized by those skilled in the art that charger 130 could be connected to any electrical energy supply, such as, for exemplary purposes only, an automobile energy source.

Insertion of wallet 10 into cradle 150 places security wallet 10 in electrical communication with charger 130 and ultimately mains power via power cord 140, wherein energy source 90 is replenished with energy and subsequently provides its stored energy for activation of flash bulb 80 once wallet 10 is removed and switch 110 is switched to the ‘on’ position, and wherein energy flows from energy source 90 to storage mechanism 100.

Further, in this alternate embodiment, selection of switch 110 to ‘off’ position reversibly places contacts 160 in electrical communication with energy source 90, wherein contacts 160 engage cooperative contacts 170 of charger 130, thereby permitting flow of electrical energy from charger 130 to energy source 90 to recharge same.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A wallet comprising:
a flash bulb; and
an activation switch.

2. The wallet of claim 1, further comprising a disabling switch.

3. The wallet of claim 1, further comprising an energy source.

4. The wallet of claim 3, wherein said energy source comprises a battery.

5. The wallet of claim 4, wherein said battery is rechargeable.

6. The wallet of claim 1, further comprising a charge storage mechanism.

7. The wallet of claim 6, wherein said charge storage mechanism comprises a capacitor.

8. The wallet of claim 7, wherein said capacitor is charged by a battery.

9. The wallet of claim 1, further comprising a concentrating lens.

10. The wallet of claim 1, wherein said flash bulb comprises a xenon flash tube.

11. The wallet of claim 2, wherein said disabling switch reversibly removes electrical communication between an energy source and a charge storage mechanism.

12. The wallet of claim 11, wherein said disabling switch reversibly engages electrical communication between charging contacts and a charger.

13. A method of disabling an assailant, said method comprising the steps of:
charging a charge storage mechanism;
carrying a wallet, having a said charge storage mechanism and a flashbulb, on a person;
upon being assailed, aiming said wallet at the assailant; and
activating the flashbulb via an activation switch, thereby disabling the assailant by temporary blinding the assailant.

14. The method of claim 13, wherein said step of charging further comprises the step of:
charging said charge storage mechanism with energy from a battery.

15. The method of claim 14, further comprising the step of:
reversibly disengaging electrical communication between said battery and said charge storage mechanism.

16. The method of claim 14, further comprising the step of:
recharging said battery.

17. A personal security apparatus for containing money, said personal security apparatus comprising:
a wallet; and
a charge storage mechanism in electrical communication with a flash bulb, wherein said charge storage mechanism and said flash bulb are disposed within said wallet.

18. The personal security apparatus of claim 17, further comprising a concentrating lens.

19. The personal security apparatus of claim 18, further comprising a switch, wherein said switch reversibly disengages electrical communication between an energy source and said charge storage mechanism and reversibly engages electrical communication between charging contacts and a charger, when said wallet is disposed in a cradle of said charger.

20. The personal security apparatus of claim 19, wherein said energy source comprises a rechargeable battery.
